(19) United States
(12) Patent Application Publication
(10) Pub. No.: US 2021/0182884 A1
(43) Pub. Date: Jun. 17, 2021

(54) Analysis of Social Media Data to Predict Customer Purchases

(71) Applicant: Wells Fargo Bank, N.A., San Francisco, CA (US)

(72) Inventors: Seth Melvin Cronin, Essex Jct, VT (US); John Edward Cronin, Bonita Springs, FL (US)

(21) Appl. No.: 14/984,079

(22) Filed: Dec. 30, 2015

(51) Int. Cl. G06Q 30/02; G06F 17/30; G06Q 50/00

(52) U.S. Cl. CPC G06Q 30/0202; G06F 17/30867; G06Q 50/01; G06F 17/30598

(57) ABSTRACT

Ordering data is received from retailers regarding customer purchases. Social media posts made by the customer are received. First, second and third textual elements are identified from the social media posts and sorted into categories. Fourth textual elements are identified from the ordering data and sorted into the categories. When a sum of the first and second textual elements for a category is greater than a predetermined threshold and when one of the first textual elements from the social media posts matches one of the fourth textual elements from the ordering data or when one of the second textual elements and one of the third textual elements are sorted into a same category and the category matches a category for one of the first textual elements from the social media posts, a prediction is made that the customer will purchase a product or a service corresponding to the category.

### BACKGROUND

Organizations, such as financial institutions and social media sites, can accumulate and store a great deal of information regarding their customers. This information can include personal data, financial data, employment history, credit history and customer purchasing history. The customer information can originate from a variety of sources and is typically disparate in nature.

### SUMMARY

Embodiments of the disclosure are directed to a method implemented on an electronic computing device for predicting customer purchases, the method comprising: on the electronic computing device, receiving from one or more retailers ordering data regarding purchases made by a customer at the one or more retailers; receiving from one or more social media sites social media posts made by the customer; identifying one or more first textual elements, one or more second textual elements and one more third textual elements from the social media posts; sorting each of the first textual elements and the second textual elements into one or more categories; identifying one or more fourth textual elements from the ordering data; sorting the one or more of fourth textual elements from the ordering data into the one or more categories; for each of the one or more categories, calculating a sum of the first textual elements and the second textual elements from the social media posts; and when the sum for a category is greater than a predetermined threshold: determining whether one of the first textual elements from the social media posts for the category matches one of the fourth textual elements from the ordering data for the category; and when the one of the first textual elements from the social media posts for the category matches the one of the fourth textual elements from the ordering data for the category or when at least one of the second textual elements and one of the third textual elements from the social media posts are sorted into a same category and the category matches a category for at least one of the first textual elements from the social media posts, making a prediction that the customer will purchase a product or a service corresponding to the category.

In another aspect, an electronic computing device comprising: a processing unit; and system memory, the system memory including instructions which, when executed by the processing unit, cause the electronic computing device to: receive from one or more retailers ordering data regarding purchases made by a customer at the one or more retailers; receive from one or more social media sites social media posts made by the customer; correlate a first aspect of the ordering data with a first aspect of the social media posts; obtain a second aspect of the social media posts; and when a combination of the first aspect of the social media posts and the second aspect of the social media posts is greater than a threshold, predict a price for a purchase of a product corresponding to the first aspect of the ordering data.

In yet another aspect, an electronic computing device includes a processing unit; and system memory, the system memory including instructions which, when executed by the processing unit, cause the electronic computing device to: receive from one or more retailers ordering data regarding purchases made by a customer at the one or more retailers; receive from one or more social media sites social media posts made by the customer; identify one or more first textual elements from the social media posts, the one or first textual elements from the social media posts corresponding to names of one or more products, brands, trade names or services mentioned in the social media posts; identify one or more second textual elements from the social media posts, the one or more second textual elements in the social media posts corresponding to one or more keywords in the social media posts, the one or more keywords corresponding to generic words that can be sorted into categories; identify one more third textual elements from the social media posts, the one or more third textual elements in the social media posts corresponding to words or phrases that can correspond to an action to be taken with respect to the first textual elements and/or the second textual elements; sort each of the first textual elements and the second textual elements into one or more categories; identify one or more of fourth textual elements from the ordering data, the one or more fourth textual elements from the ordering data corresponding to one or more products, brands, trade names or services that the customer has already purchased; sort the one or more of the fourth textual elements from the ordering data into the one or more categories; for each of the one or more categories, calculate a sum of the first textual elements and the second textual elements from the social media posts; when the sum for a category is greater than a predetermined threshold: generate a template corresponding to the category; and determine whether one of the first textual elements from the social media posts for the category matches one of the fourth textual elements from the ordering data for the category; and when the one of the first textual elements from the social media posts for the category matches the one of the fourth textual elements from the ordering data for the category or when at least one of the second textual elements and one of the third textual elements from the social media posts are sorted into a same category and the category matches a category for at least one of the first textual elements from the social media posts: fill in fields in the template with names of the one or more first textual elements, the one or more second textual elements and the one or more third textual elements for the category from the social media posts; receive a selection for a predicted purchase price, a predicted purchase date or a predicted purchase brand; based on the selection, fill in fields in the template with the predicted purchase price, the predicted purchase date or the predicted purchase brand for a product, brand, trade name or service to be purchased; and fill in a field in the template with a number indicating an accuracy of the predicted purchase price, the predicted purchase date or the predicted purchase date.

The details of one or more techniques are set forth in the accompanying drawings and the description below. Other features, objects, and advantages of these techniques will be apparent from the description, drawings, and claims.

### DESCRIPTION OF THE DRAWINGS

FIG. 1 shows an example system that supports an analysis of social media data to predict customer purchases.

FIG. 2 shows example modules of the system of FIG. 1.

FIG. 3 shows an example template for predicting customer purchases.

FIG. 4 shows another example template for predicting purchases.

FIG. 5 shows yet another example template for predicting customer purchases.

FIG. 6 shows an example NLP data structure.

FIG. 7 shows an example historical data structure.

FIG. 8 shows an example prediction matrix.

FIG. 9 shows a flowchart of an example method for using a natural language processor to identify textual elements from social medial posts from a customer.

FIG. 10 shows a flowchart of an example method for using natural language processing to parse ordering data from an online retailer for a customer.

FIG. 11 shows a flowchart of an example method for creating a template from a category.

FIG. 12 shows a flowchart of an example method for loading data into a template from FIG. 11.

FIG. 13 shows a flowchart of an example method for making a prediction using a template from FIG. 12.

FIG. 14 shows example physical components of the server computer of FIG. 1.

### DETAILED DESCRIPTION

The present disclosure is directed to systems and methods that can analyze customer posts from social media sites to predict customer purchases. The customer posts can be parsed to identify brand, product or tradenames, keyword indicators and context indicators from the customer posts. Information obtained from the social media sites can identify products or services that the customer may be interested in purchasing in the future. In addition, a prediction can be made as to a likelihood the customer will purchase the products or services in the future.

The systems and methods can also be used to obtain information regarding customer purchases from retail organizations. The information regarding the customer purchases and the information obtained from the social media sites can be used in conjunction with personal information the organization may have regarding the customer to predict future products that the customer may purchase. When the organization makes a determination that the customer is likely to purchase a product or a service in the near future, the organization can sometimes take proactive steps to help the customer with financing the product, recommending a specific product to the customer, recommending a product or service that can complement the product to be purchased or offer a coupon or other promotions as an inducement to the customer to purchase the product or service. Other proactive steps or actions can be taken by the organization.

Using the systems and methods, customer data from social media sites, for example customer social media posts, can be parsed, for example using natural language processing. Products, brands and trade names can be identified from the social media posts. In addition, keywords and context indicators can be identified from the social media posts. Products, brands and trade names can also be identified from actual customer ordering data. The products, brands, trade names and keywords can be sorted into categories. When a sum of the products, brands and tradenames and keywords are greater than a threshold for a category for a customer, an action can be performed, such as generating a template corresponding to the category. Then when there is an additional match between a product, brand or trade name identified from a social media post and a product, brand or trade name identified from the customer ordering history, fields in the template can be populated with the natural language processor data. Although natural language processing is described for parsing the social media data, other methods of parsing the social media data can be used. For example, one method can comprise an analysis of cookies and metadata associated with social media data. Another method can comprise a user-generated system of tagging, such as Twitter's #hashtag system. Still other methods of parsing the social media data are possible.

As discussed in more detail later herein, each template for a category displays data obtained from the social media posts regarding the category. In addition, each template displays a prediction regarding a possible customer purchase of a product or a brand corresponding to the category. Further, each template permits a financial institution employee to select a type of prediction to be made regarding the matched product, brand or trade name for the category. Example types of predictions can include a predicted product or brand to purchase, a predicted date on which the product is to be purchased and a predicted purchase prices. Other types of predictions are possible. Each template also displays a correlation value that indicates a degree to which the prediction is accurate.

In this disclosure, the use of social media data and order history data to predict future customer purchases are described with respect to financial organizations such as a bank. However, the systems and methods described herein are also applicable to other types of organizations and for other purposes. For example, the systems and methods can be used to target customers for promotions, to assess credit and risk both with and without the use of credit agencies and to predict how financial programs and devices can affect certain customer bases. Other examples are possible.

The systems and methods disclosed herein are directed to a computer technology that helps solves an existing problem in predicting customer purchasing behavior. The systems and methods improve efficiencies of predicting customer purchasing behavior by a systematic analysis of customer social media posts and customer ordering data. By proactively identifying customers that may be making imminent purchases of products or services, a financial organization can proactively target customers with added inducements to purchase the products or services. The added inducements can comprise advertisements, promotions, coupons, etc. Proactively targeting customers improves computing efficiencies because targeted customers are identified efficiently and customer inquiries such as email messages can be minimized.

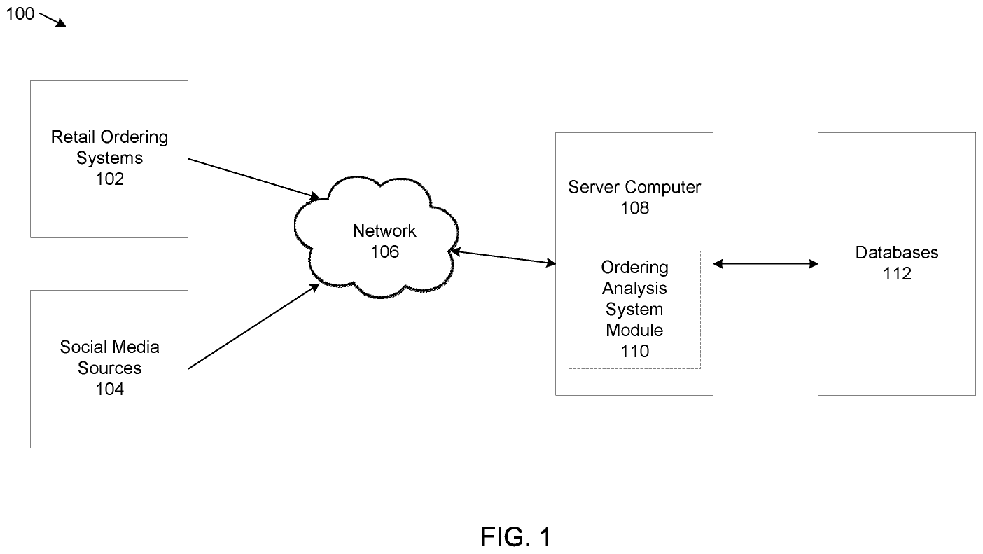

FIG. 1 shows an example system 100 that supports an analysis of social media data to predict customer purchases. The example system 100 includes retail ordering systems 102, social media sources 104, a network 106, a server computer 108 and databases 112. Server computer 108 includes an ordering analysis system module 110.

The example retail ordering system 102 include ordering systems from retailers from which customer ordering information can be obtained over network 106. The retailers can include brick and mortar retailers and online retailers. The brick and mortar retailers can include retailers such as department stores, specialty stores, car dealerships and restaurants. The online retailers can include retailers such as amazon.com, kayak.com and zappos.com. Other brick and mortar and online retailers are possible.

Information regarding customer purchases at these retailers can be obtained from the ordering systems of the retailers. The information can be obtained using an application program interface (API) on the ordering systems of these retailers. A financial organization can obtain data regarding customer purchases using the API of each retailer. In order for the financial organization to obtain the data using the API, the customer typically needs to authorize the retailers to send the data to the financial institution.

The example social media sources 104 include social media websites such as Facebook, Twitter, LinkedIn, Instagram, etc. Customers can post comments on the social media websites regarding purchases they have made, products, brands or services they are interested in purchasing, interests and plans that they have, etc. Many of the social media websites have APIs by which the customer posts can be obtained by interested parties. In order for an interested party to be able to obtain the customer posts via the API, the customer typically needs to authorize the social media websites to permit access by the interested parties.

The example network 106 is a computer network by which the retail ordering systems 102 and the social media sources 104 can communicate with server computer 108. For system 100, network 106 is the Internet.

The example server computer 108 is a server computer of the financial institution. Server computer 108 can comprise one server computer or a plurality of server computers.

The example databases 112 are databases than can be accessed by the server computer 108. In some implementations, databases 112 comprise one database. In other implementations, server computer 108 comprises a plurality of databases. The databases 112 can include personal data regarding a customer, including financial data. The databases 112 can also include a brand and product database and a customer profile database. Other databases are possible. The brand and product database can include information regarding brands and products that the customer has previously purchased. The customer profile database can include, among other things, templates that can predict future customer purchases. The brand and product database and the customer profile database are explained in more detail later herein.

The example ordering analysis system module 110 includes a plurality of modules that can process customer ordering information from the retail ordering systems 102 and from the social media sources 104 and predict which future products and/or brands the customer may purchase in the future. The ordering analysis system module 110 is described in more detail next herein.

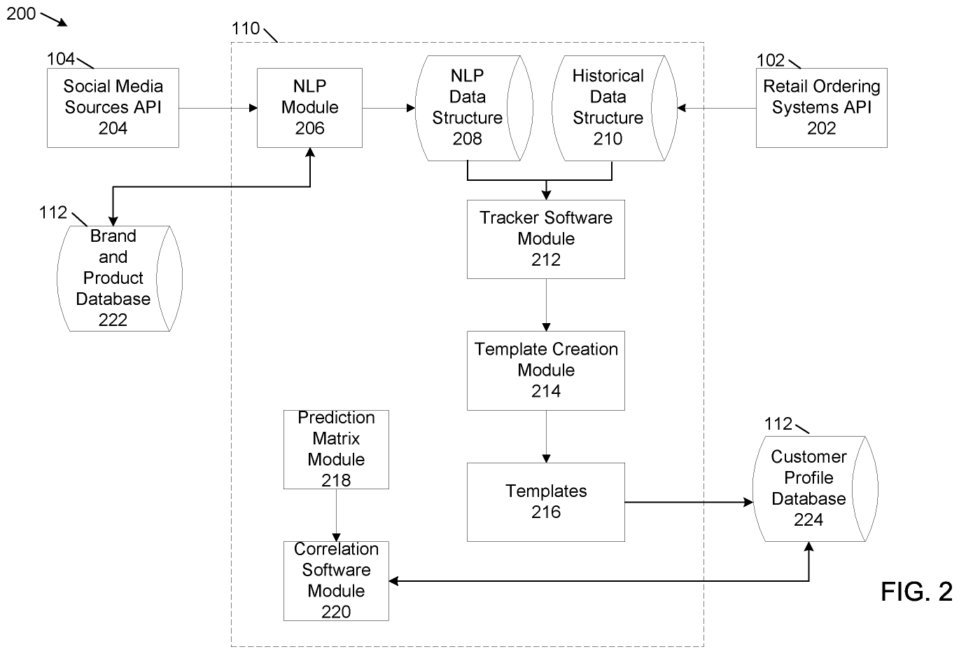

FIG. 2 shows an example system 200 which includes the retail ordering systems 102, the social media sources 104, the ordering analysis system module 110 and databases 112. The system 200 includes a social media sources API 204 and a retail ordering systems API 202. The ordering analysis system module 110 can obtain customer social media posts from social media sources API 204. The ordering analysis system module 110 can obtain customer purchase data from the retail ordering systems API 202.

The ordering analysis system module 110 includes a NLP (natural language processor) module 206, a NLP data structure 208, a historical data structure 210, a tracker software module 212, a template creation module 214, templates 216, a prediction matrix module 218 and a correlation software module 220.

The example NLP module 206 receives social media data from the social media sources API 204 and identifies personal customer information, brand, product or trade names, keywords indicators and context indicators in the social media data. The social media data can include posts that the customer made on the social media websites. The social media data can include a customer name, a name and location (if applicable) of a social media website and a text string. The social media data can be parsed to identify and or extract the customer name, location, brand, product or trade names, keyword indicators, context indicators and other information from the social media data. The parsed social media data can be stored in the NLP data structure 208, as discussed in more detail later herein. In addition, the brand and product information can be stored in the brand and product database 222.

The example keywords indicators are words representing a type of product or service that the customer can purchase. A detection of a keyword indicator in the customer social media data can indicate that the customer is interested in purchasing a product or service corresponding to the type. The keyword indicators can be pre-configured for the ordering analysis system module 110 to correspond to types of products that may be of interest to the customer. Examples of keyword indicators can be car, truck, tires, flight, necklace, dinner, TV, movies, hotel, taxi, kitchen, real estate, tile and carpet. Other keyword indicators are possible.

The example context indicators are words or phrases that can represent a context for purchasing a product or a service. A detection of a context indicator in conjunction with a keyword indicator and product name can indicate that the customer is interested in purchasing the product. The way in which a detection of context indicators, keyword indicators and product names can predict a product purchase is described in more detail later herein. Examples of context indicators can be recommend, shopping, budget, review, buy, new, old, used, finance, purchase, shipping, searching, upgrade, renovate and remodel. Other context indicators are possible.

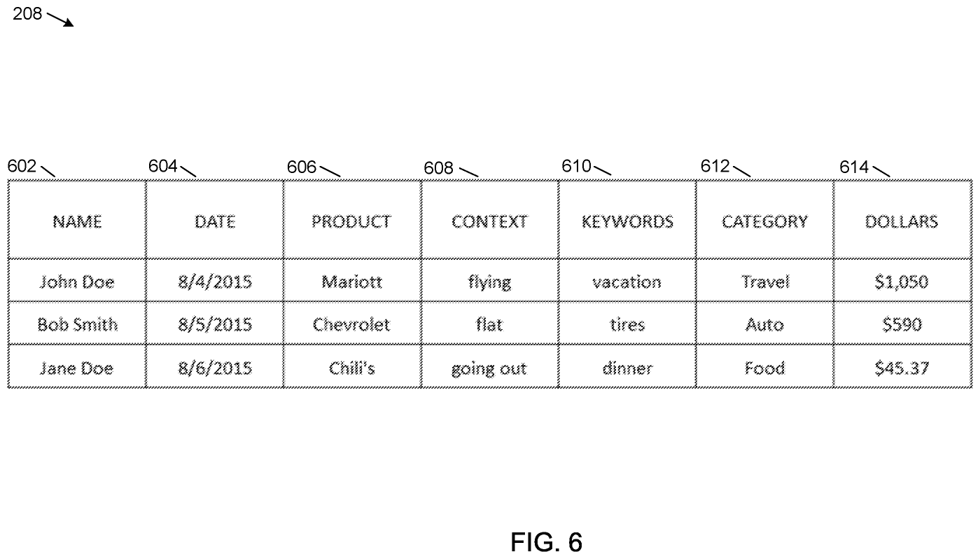

The example NLP data structure 208 comprises a data structure that organizes customer purchase information so that the customer purchase information can be easily stored, accessed and processed. An example format of the NLP data structure 208 is described in more detail later herein. See FIG. 6.

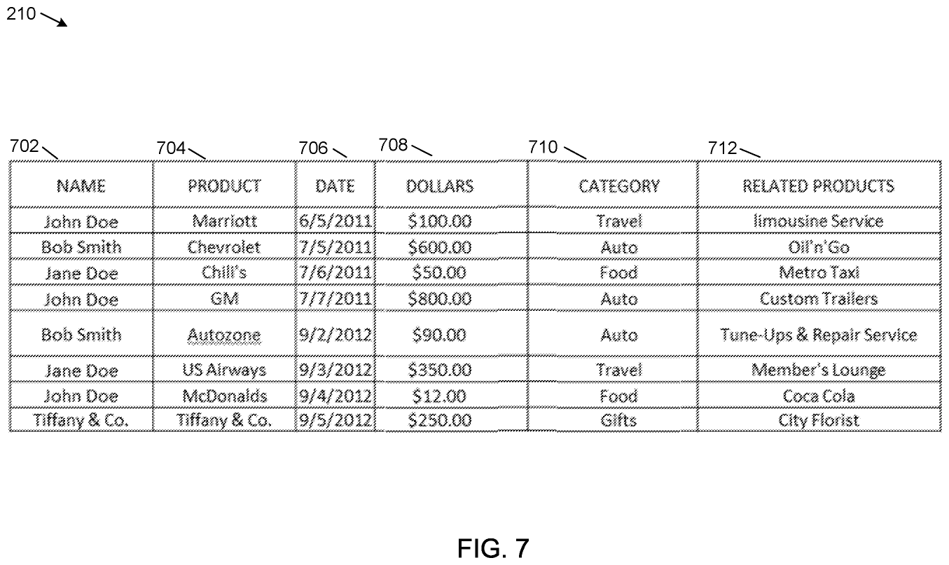

The example historical data structure 210 comprises a data structure that organizes information regarding actual customer purchases of products and services. An example format of the historical data structure 210 is described in more detail later herein. See FIG. 7.

The example tracker software module 212 receives one or more of product and brand name information, keyword indicators and context indicators from the NLP data structure 208 and the historical data structure 210, sorts the information and indicators received into categories and determines whether the number of product or brand names and keyword indicators in any one category is greater than a predetermined threshold. When the number of product or brand names and keyword indicators in any one category is greater than the predetermined threshold, the example template creation module 214 creates a template for the product or brand names. For the ordering analysis system module 110, the predetermined threshold is three, meaning that the template is created when the number of identified product or brand names, keyword indicators and context indicators that are sorted into one category is greater than three. Other predetermined thresholds can be used.

For examples of sorting product or brand names, a brand name identified as “Chevrolet” be sorted into an “auto” category, a brand name identified as “Delta Airlines” can be sorted into a “travel” category, a brand name identified as “Pizza Hut” can be sorted into a “food” category. For examples of sorting keyword indicators into categories, a keyword identified as “tires” can be sorted into the “auto” category, a keyword identified at “flight” can be sorted into the “travel” category, a keyword identified as “necklace” can be sorted into a “gifts” category, a keyword identified as “dinner” can be sorted into the “food” category, a keyword identified as “movies” can be sorted into an “entertainment” category and a keyword identified as “hotel” can be sorted into the “travel” category. Other examples are possible.

The tracker software module 212 can also compare data from the NLP data structure 208 with data from the historical data structure 210 to determine whether there is a match for at least one brand name, product name or trade name. If there is a match, the template creation module 214 loads NLP data into a template corresponding to a category for the matched brand name, product name or trade name. In addition, if there is a match for at least one context indicator and at least one keyword indicator, the template creation module 214 loads NLP data into a template corresponding to a category for the matched keyword.

As discussed, the template creation module 214 creates a template corresponding to product category when the predetermined threshold is greater than three and when there is a match between product names and between keyword indicators and context indicators. In addition, when the predetermined threshold is not greater than three and when there isn't a match between product names and between keyword indicators and context indicators, the template creation module 214 creates a generic template and loads NLP data into the generic template. The templates can be used to predict whether a product corresponding to the template is likely to be purchased by the customer.

The example templates 216 comprise templates corresponding to the different product categories. As discussed, the template creation module 214 creates the templates when certain conditions are met. The templates that are created can be stored in the customer profile database 224. Specific aspects of selected templates is discussed in more detail later herein.

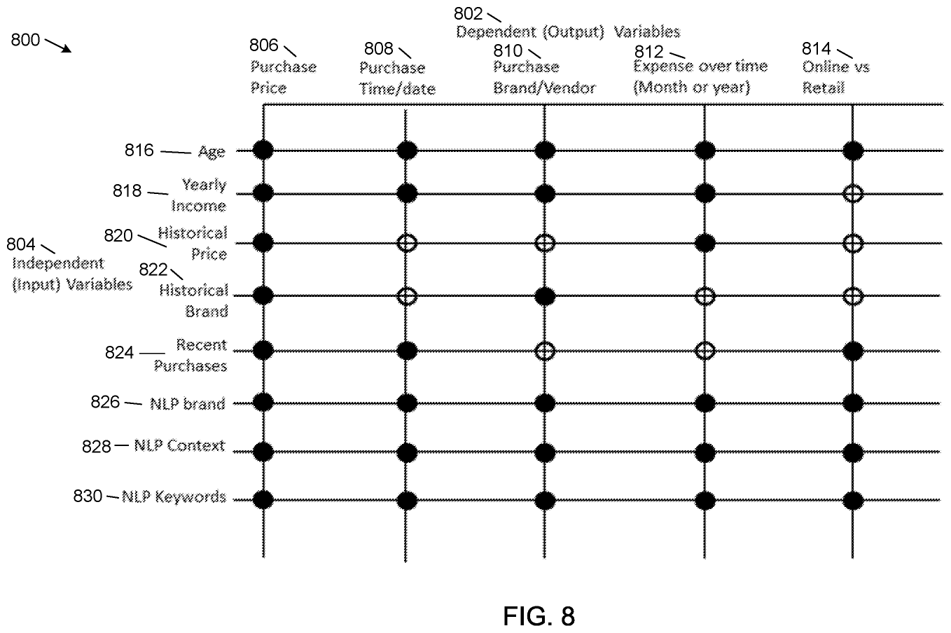

The example prediction matrix module 218 processes data from a prediction matrix (see FIG. 8) and from historical data (see FIG. 7) to determine coefficients of a regression equation that can predict outcomes from the prediction matrix. For example, if an outcome of the prediction matrix is a purchase price, the prediction matrix can indicate independent variables that can be used in the regression equation to predict the purchase price. For a prediction of a purchase price, the independent variables can be age, yearly income, historical price, historical brand, recent purchases, and a brand, context and keywords (as identified from NLP module 206).

An example regression equation can be:

f(y)=β₀X₀+β₁X₁+β₂X₂+β₃X₃ . . . βₙXₙ+ϵ (1)

where, β₀, β₁, β₂, β₃ . . . βₙ are coefficients, X₀, X₁, X₂, X₃ . . . Xₙ are independent variables and is a random error component.

The prediction matrix module 218 can use a data model with the historical data to determine the coefficients β₀, β₁, β₂, β₃ . . . βₙ. The independent variables X₀, X₁, X₂, X₃ can correspond to the age, yearly income, historical price, historical brand, respectively. The outcome f(y) of equation (1) can represent the predicted purchase price. For the example prediction matrix module 218, the ordinary least squares (OLS) model is used to estimate the coefficients.

A regression equation similar to equation (1) can be used to predict outcomes such as a purchase time/date, a purchase brand/vendor, an expense over a month or year, a prediction of an online or retail purchase, and other outcomes, based on a separate set of dependent variables as determined by the prediction matrix. As described in more detail later herein, the prediction matrix can indicate a selection of different sets of independent/dependent variables that can predict different outcomes.

The example correlation software module 220 can calculate a correlation value for the regression equations (similar to equation (1)) that predict the different outcomes. The correlation value indicates how close the actual historical data is to fitting a regression line corresponding to equation (1). For the example ordering analysis system module 110, the coefficient of determination (R²) is used to indicate how close the historical data is the regression line. The coefficient of determination is described in more detail with regard to a discussion of the templates later herein.

The example customer profile database 224 stores templates 216 that are created by the template creation module 214. The customer profile database 224 also receives R² correlation data from the correlation software module 220 and stores the R² correlation data in the templates 216.

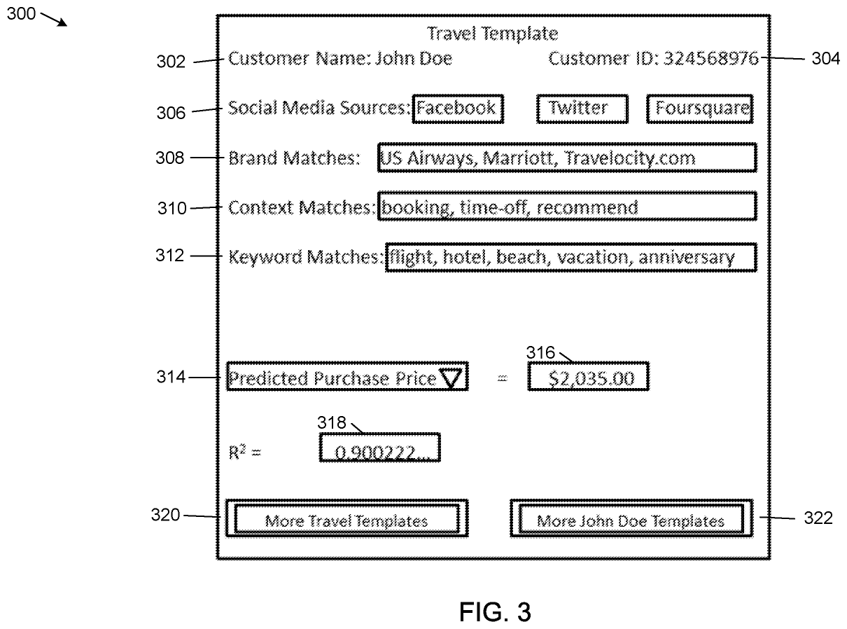

FIG. 3 shows one of the example templates 216. The templates 216 are directed to specific product categories, such as travel, auto and food. As discussed earlier herein, each template displays information obtained from social media sources and also permits a financial institution employee to select an item for which a prediction can be made. Examples items for which a prediction can be made include a product or brand to be purchased, a purchase date and a purchase price.

The template shown in FIG. 3 is an example travel template 300. The travel template 300 is created when the tracker software module 212 determines that the number of product or brand names and keyword indicators in the travel category is greater than the predetermined threshold. The travel template 300 includes a customer name 302, a customer ID 304, social media sources 306, brand matches 308, context matches 310 and keyword matches 312. For the travel template 300, the social media sources 306 are shown to be Facebook, Twitter and Foursquare, the brand matches 308 are shown to be US Airways, Marriott and Travelocity.com, the context matches 310 are shown to be booking, time-off and recommend and the keyword matches 312 are shown to be flight, hotel, beach, vacation and anniversary.

The travel template 300 also includes a pulldown list box 314, a predicted value 316 of the pulldown list box 314 and a R² value 318 for the predicted value. The pulldown list box 314 permits a selection of items to be predicted, such as a predicted purchase price, a predicted purchase time/date, a predicted brand/vendor, a predicted monthly or yearly expense and a prediction as whether a predicted purchase is to occur online or at a retail location. Other predicted items are possible. In some implementations, the predicted purchase price is a default selection. In other implementations, the predicted purchase price can be the only selection. For the example travel template 300, the predicted value 316 for the purchase price is estimated to be $2,035.00. The R² value is estimated to be 0.90022. The R² value shows that the predicted purchase price of $2,035.00 has about a 90% probability of being accurate.

The travel template 300 also permits a selection of more travel templates 320 and more templates 322 from the same customer, John Doe.

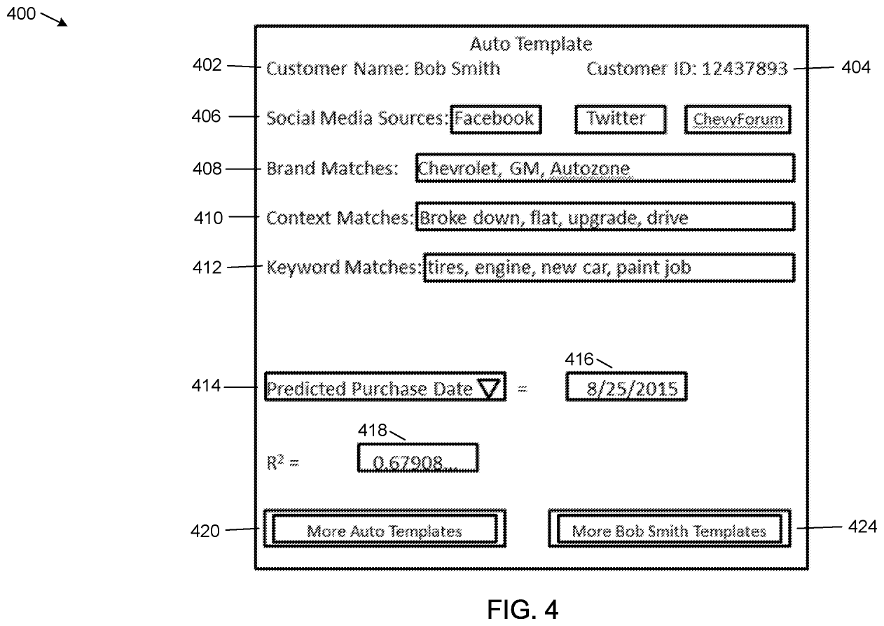

FIG. 4 shows another one of the example templates 216. The template shown in FIG. 4 is an example auto template 400. The auto template 400 is created when the tracker software module 212 determines that the number of product or brand names and keyword indicators in the auto category is greater than the predetermined threshold. The auto template 400 includes a customer name 402, a customer ID 404, social media sources 406, brand matches 408, context matches 410 and keyword matches 412. For the auto template 400, the social media sources 406 are shown to be Facebook, Twitter and Chevy Forum, the brand matches 408 are shown to be Chevrolet, GM and Autozone, the context matches 410 are shown to be broke down, flat, upgrade and drive and the keyword matches 412 are shown to be tires, engine, new car and paint job.

The auto template 400 also includes a pulldown list box 414, a predicted purchase date 416 of the pulldown list box 414 and a R² value 418 from for the predicted purchase date. The pulldown list box 414 permits a selection of items to be predicted, such as a predicted purchase price, a predicted purchase time/date, a predicted brand/vendor, a predicted monthly or yearly expense and a prediction as whether a predicted purchase is to occur online or at a retail location. Other predicted items are possible. For the example auto template 400, the predicted purchase date 416 is estimated to be Aug. 25, 2015. The R² value is estimated to be 0.67908. The R² value shows that the predicted purchase date of Aug. 25, 2015 has about a 68% probability of being accurate.

The auto template 400 also permits a selection of more auto templates 420 and more templates 422 from the same customer, Bob Smith.

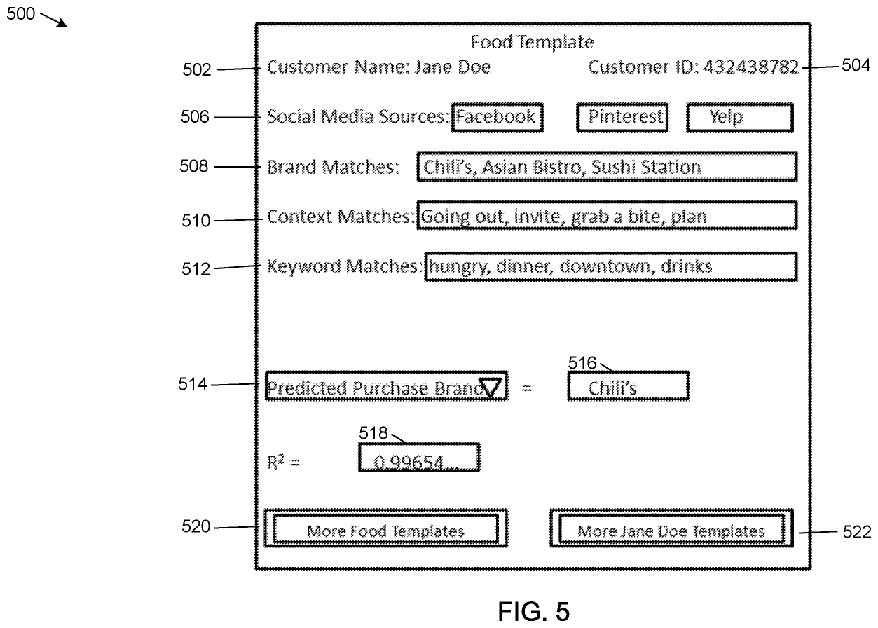

FIG. 5 shows yet another one of the example templates 216. The template shown in FIG. 5 is an example food template 500. The food template 500 is created when the tracker software module 212 determines that the number of product or brand names and keyword indicators in the food category is greater than the predetermined threshold. The food template 500 includes a customer name 502, a customer ID 504, social media sources 506, brand matches 508, context matches 510 and keyword matches 512. For the food template 500, the social media sources 506 are shown to be Facebook, Pinterest and Yelp, the brand matches 508 are shown to be Chili's, Asian Bistro and Sushi Station, the context matches 510 are shown to be going out, invite, grab a bite and plan and the keyword matches 512 are shown to be hungry, dinner, downtown and drinks.

The food template 500 also includes a pulldown list box 514, a predicted purchase brand 516 of the pulldown list box 514 and a R² value 518 from for the predicted purchase brand. The pulldown list box 514 permits a selection of items to be predicted, such as a predicted purchase price, a predicted purchase time/date, a predicted brand/vendor, a predicted monthly or yearly expense and a prediction as whether a predicted purchase is to occur online or at a retail location. Other predicted items are possible. For the example food template 500, the predicted purchase brand 516 is predicted to be Chili's. The R² value is estimated to be 0.99654. The R² value shows that the predicted purchase brand of Chili's has over a 99% probability of being accurate.

The food template 500 also permits a selection of more food templates 520 and more templates 522 from the same customer, Jane Doe.

FIG. 6 shows additional details about the example NLP data structure 208. As noted, the NLP data structure 208 organizes customer purchase information so that the customer purchase information can be easily stored, accessed and processed. As shown in FIG. 6, the example NLP data structure 208 includes columns for name 602, date 604, product 606, context 608, keywords 610, category 612 and dollars 614. Each name 602 corresponds to a name of a customer of the financial institution and each date 604 corresponds to a purchase date of a product 606. Each context 608 corresponds to words or phrases that can represent a context for purchasing the product 606. For example, flying can be a context for a trip during which the customer stays at a Marriot hotel. Each keyword 610 corresponds to words representing a type of product that can be related to the product 606. For example, vacation can be a keyword for a trip during which the customer stays at the Marriot hotel. Each category 612 corresponds to a category to which the product 606, context 608 and keywords 610 have been sorted. Each entry in the dollars 614 column corresponds to a predicted price for a product 606. Rows of the NLP data structure 208 are filled when social media data from social media sources 104 is parsed by the NLP module 206.

FIG. 7 shows additional details about the example historical data structure 210. As noted, the historical data structure 210 organizes information regarding actual customer purchases of products and services. As shown in FIG. 7, the example historical data structure 210 includes columns for name 702, product 704, date 706, dollars 708, category 710 and related products 712. Each name 702 corresponds to a customer name, each product 704, corresponds to a product that has been purchased by the customer, each date 706 corresponds to a date at which the product 704 has been purchased, each dollars 706 corresponds to a purchase price for the product 704, each category 710 corresponds to a category to which the product 704 has been sorted and each related products 712 corresponds to products that are related the product 704 that the customer has used, based on an ordering history for the customer.

Rows of the historical data structure 210 are filled when retail ordering data from retail ordering systems 102 is entered into the historical data structure 210. The historical data structure 210 shows a record of each retail order. For example, row one shows that on Jun. 5, 2011, John Doe ordered a limousine service from Marriott and paid $100.00.

FIG. 8 shows an example prediction matrix 800. The prediction matrix 800 shows independent (input) variables 804 in the rows of the prediction matrix 800 and dependent (output) variables 802 in the columns of the prediction matrix 800. The example independent variables 804 include age 816 of the customer, yearly income 818 of the customer, an historical price 820 of an item that can be purchased, a historical brand 822 of the item that can be purchased, recent purchases 824 of the customer, an NLP brand 826 (representing a product brand identified by natural language processing of social media data), and NLP context 828 (representing a context identified by the natural language processing of the social media data) and NLP keywords 830 (representing keywords identified by the natural language processing of the social media data). The example dependent variables 802 include a purchase price 806, a purchase time/date 808, a purchase brand/vendor 810, an expense over time 812 and an online vs. retail predictor 814. The dependent variables 802 correspond to selected outcomes of the templates 216. For example, purchase price 806 corresponds to a selection of pulldown list box 314 for the travel template of FIG. 3, purchase time/date 808 corresponds to a selection of pulldown list box 414 for the auto template of FIG. 4 and purchase brand/vendor 810 corresponds to a selection of pulldown list box 514 of FIG. 5. The expense over time 812 corresponds to a prediction of customer expenditures over a period of time, for example over a month or a year. The online vs. retail predictor corresponds to a prediction as to whether the customer will make an online purchase or a purchase at a retail store.

The prediction matrix 800 shows which independent variables 804 are used to obtain a specific prediction of a dependent variable 802. The independent variables 804 that are used for a specific prediction of the dependent variables 802 are indicated by a solid dot at the intersection of an independent variable 804 and a dependent variable 802. For example, for the prediction of a purchase brand/vendor 810, the independent variables used include age 816, yearly income 818, historical brand 822, NLP brand 826, NLP context 828 and NLP keywords 830. For the prediction of the purchase brand/vendor 810, independent variables for historical price 820 and recent purchases 824 are not used.

As discussed earlier herein, the systems and methods of this disclosure can be applied to organizations other than financial institutions. In other example uses, the systems and methods can be used to retrieve user geolocation, home address, etc., to incorporate geography-based price decisions into predictive models. In another example system, customers can view their own profiles and predictions regarding their behavior. Customers can set a financial plan and offer comparisons between the predicted, the plan and actual purchasing behavior. In yet another example, users can opt-in to have device metadata sent to the ordering analysis system module 110 to inform predictive templates. Metadata could include search terms that the user has entered, websites browsed, devices and operating systems used, etc. In yet another example, advertisers can be allowed to receive notifications when customers are most likely to be engaging in purchasing behavior, delivering individually targeted discounts, advertisements or other promotional material to the customer's social media sources. In yet another example, incentives can be offered to customers for providing more sensitive or private data, such as text messages, emails, chat logs, notes, journals, etc. In yet another example, large cohorts of customers with similar purchasing behavior can be studied regularly to improve a prediction matrix. Less intuitive independent variables can be used, such as a number of friends, social media posts per hour, religious/marital status, purchases made by friends, use of games or apps, social events calendar, etc.

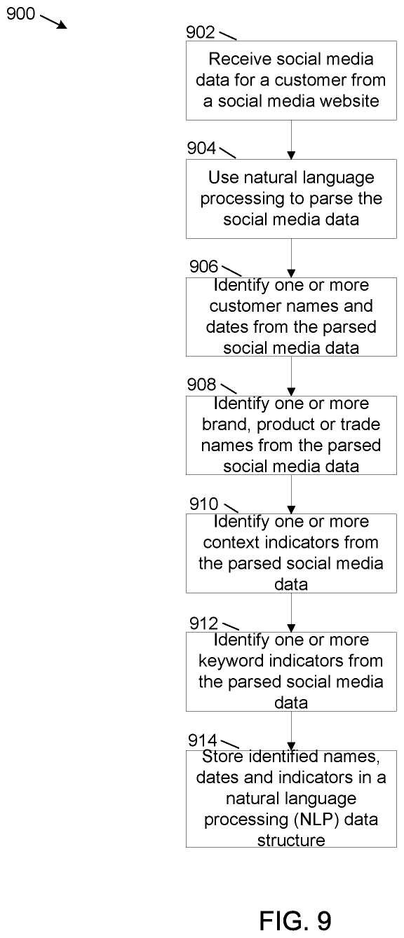

FIG. 9 shows a flowchart of an example method 900 for using a natural language processor to identify textual elements from social medial posts from a customer. The identified textual elements are then stored in a natural language processing (NLP) data structure for future use.

At operation 902, social media data for a customer is received from a social media website. The social media data includes social media posts that the customer has made on the social media websites. The social media posts can include posts related to purchases that the customer is thinking of making, opinions of products or services or discussions related to food, travel, gifts, household appliances, automobiles or other items. Alternatively, or in addition to this content, the social media posts can include other various types of content.

At operation 904, the social media posts are parsed using a natural language processor. The natural language processor identifies textual elements in the social media posts that can be used to make a prediction as to whether the customer will purchase a product or a service in the near future. The textual elements can include one or more of customer names, dates of social media posts for the customer, products, brands and trade names that can be identified in the social media posts. The textual elements can also include one or more keywords or contexts associated with the possible purchase of the products, brands, trade names and services. The textual data can also include a price mentioned regarding one of the products, brands, trade names and services.

At operation 906, one or more customer names and dates of social media posts for the customer are identified from the parsed social media data. The natural language processor can be used to identify the one or more customer names and dates from the parsed social media data.

At operation 908, one or more brands, products or trade names are identified from the parsed social media data. The natural language processor can be used to identify the one or more brands, products or trade names are identified from the parsed social media data.

At operation 910, one more context indicators are identified from the parsed social media data. The natural language processor can be used to identify the one or more context indicators. The context indicators represent words or phrases that can correspond to an action to be taken with respect to the first textual elements and/or the second textual elements. Examples of context indicators can include recommend, booking, time-off, broke down, flat, upgrade, drive, going out, invite, grab a bite and plan. Other context indicators can be used.

At operation 912, one or more keyword indicators are identified from the parsed social media data. The natural language processor can be used to identify the one or more keyword indicators. The keyword indicators represent generic words that can be sorted into categories. Examples of keyword indicators can include flight, hotel, beach, vacation, anniversary, tires, paint job, hungry, dinner, downtown and drinks. Other keyword indicators can be used.

As described in operations 906-912, the textual elements are identified from the parsed social media data. However, it should be understood that in an actual implementation, the textual elements can be identified as the social media data is parsed. For example, during the parsing of the social media data, a customer name can be identified, followed by a date, followed by a product, followed by a keyword, followed by another customer name, etc. A plurality of different combinations in which the textual elements can be identified are possible.

At operation 914, the identified customer names, dates, brands, products, trade names, context indicators and keyword indicators are stored in a natural language processing (NLP) database, similar to the NLP database shown in FIG. 6. In addition, if a price of an item can be identified in the social media data, the price is also stored in the NLP database.

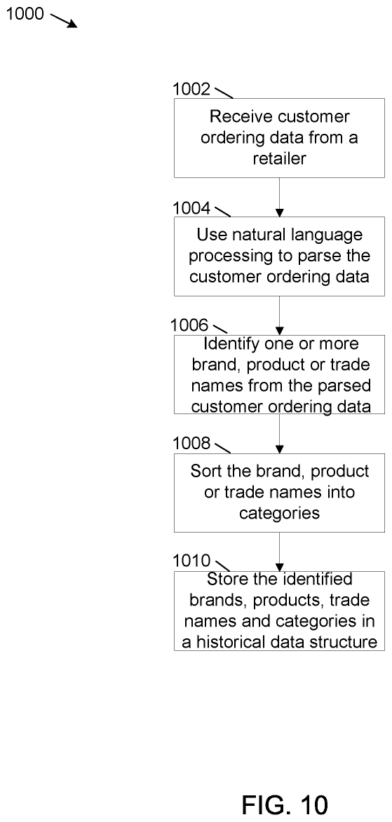

FIG. 10 shows a flowchart of an example method 1000 for using natural language processing to parse ordering data from an online retailer for a customer. The ordering data comprises data for products that the customer has already purchased.

At operation 1004, customer ordering data is received for a customer. The customer ordering data can be received via an API on a website for the online retailer or from a retail point of sale (POS) device. Example online retailers can include amazon.com and kayak.com. Both the online retailers and the retailers associated with the POS device need to have been given permission from the customer to send the customer ordering data to the financial institution.

At operation 1006, one or more brands, products or trade names can be identified from the customer ordering data. Other information can also be identified from the customer ordering data including the name of the customer who purchased the brands or products, the date of the purchase, a dollar value of the purchase and related products. Additional or different information can be identified from the customer ordering data.

At operation 1008, the brands, products or trade names are sorted into categories. For example, a brand like Chevrolet can be sorted into an auto category, a brand like Marriot can be sorted into a travel category and a trade name like McDonald's can be sorted into a food category. Other categories are possible.

At operation 1010, the identified brands, products, trade names and categories are stored in an historical database, for example in historical data structure 210.

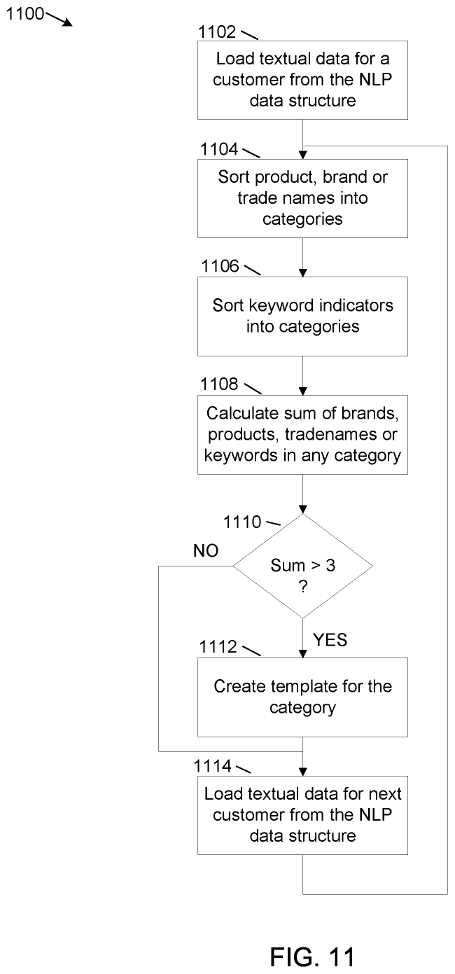

FIG. 11 shows a flowchart of an example method 1100 for creating a template from a category. The template can include information such as customer name and ID, social media sources, brand, product or trade name matches, context matches and keyword matches. The template can include a prediction regarding a purchase for a product or service corresponding to the category.

At operation 1102, textual data for the customer is loaded from the NLP data structure 208 into the tracker software module 212. The textual data includes the brand, product and trade name information that is created using method 1000.

At operation 1104, the product, brand or trade name information is sorted into categories. Example categories can include, auto, travel, food and gifts. Other categories are possible.

At operation 1106, keyword indicators from the textual data are sorted into categories. For example a keyword indicator such as hungry can be sorted into a food category and a keyword indicator such as tires can be sorted into the auto category.

At operation 1108, a sum is calculated of the number of brands, products, tradenames or keyword indicators in a single category.

At operation 1110, a determination is made as to whether the sum is greater than three. When a determination is made that the sum is greater than three, at operation 1112, a template is created for the category. Example templates, corresponding to FIGS. 3-5 were described earlier herein.

When a determination is made that the sum is not greater than three, at operation 114, textual data for a next customer is loaded from the NLP data structure 208 into the tracker software module 212.

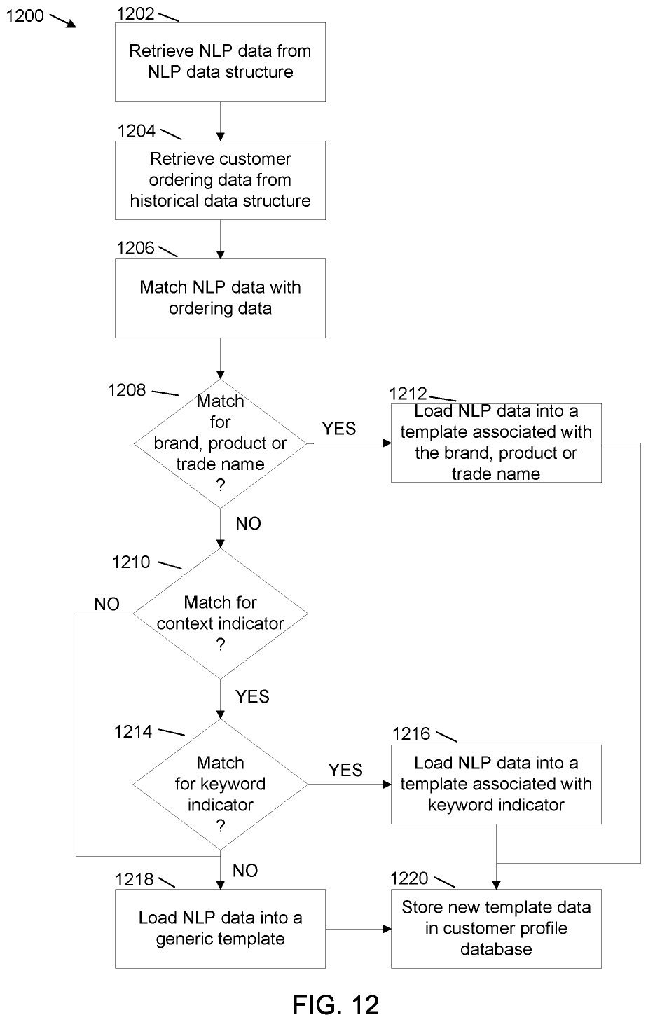

FIG. 12 shows a flowchart of an example method 1200 for loading textual data from the NLP data structure 208 into a specific template for a category and using the textual data to make a prediction as to whether the customer is likely to purchase a product or service corresponding to the category.

At operation 1202, NLP data is retrieved from the NLP data structure 208. At operation 1204, customer ordering data is retrieved from the historical data structure 210.

At operation 1206, an attempt is made to match NLP data with ordering data.

At operation 1208, a determination is made as to whether there is at least one match between a brand, product or trade name between the NLP data and the ordering data. The match is done to determine whether a product, brand or trade name being mentioned in the social media posts for the customer is a product, brand or trade name that has already been purchased by the customer.

When a determination is made that there is a match for the brand, product or trade name between the NLP data and the ordering data, at operation 1212, the NLP data is loaded into a template associated with the brand, product or trade name. The loading of the NLP data into the template associated with the brand, product or trade name comprises filling in template fields with the NLP data. At operation 1220, the template data is stored in a customer profile database.

When a determination is made that there isn't a match for the brand, product or trade named between the NLP data and the ordering data, at operation 1210, a determination is made as to whether there is a match for a context indicator. This comprises determining whether a brand, product or trade name from the NLP data has a corresponding context indicator for a specific category. For example, a brand Chevrolet can have a context indicator such as broke down, flat or upgrade.

When a determination is made at operation 1210 that there is a match for the context indicator, at operation 1214 a determination is made as to whether there is a match for a keyword indicator. This comprises determining whether a brand, product or trade name for the NLP data has a corresponding keyword indicator for a specific category. For example, the brand Chevrolet can have a keyword indicator such as tires, engine, new car or paint job.

When a determination is made at operation 1214 that there is a match for the keyword indicator, at operation 1216 the NLP data is loaded into a template associated with the keyword indicator. The loading of the NLP data into the template associated with the keyword indicator comprises filling in the template fields with NLP data. At operation 1220, the template data is stored in a customer profile database.

When a determination is made at operation 1214 that there is no match for the keyword indicator, at operation 1218, the NLP data is loaded into a generic template.

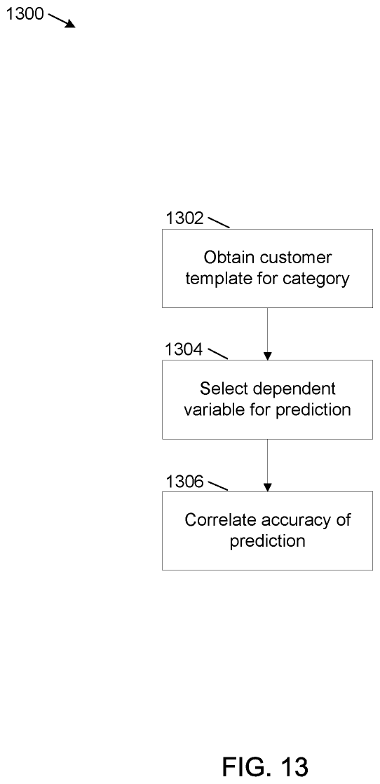

FIG. 13 shows a flowchart of an example method 1300 for making a prediction as to whether the customer is likely to purchase a product corresponding to a template category.

At operation 1302, a customer template is obtained for a category.

At operation 1304, a dependent variable is selected from the template for a prediction. Examples or dependent variables that can be selected for the prediction include a predicted purchase price, a predicted purchase date and a predicted purchase brand. These dependent variables can be selected from a pull-down list box on the template. For example, as show in FIG. 3, the predicted purchase price is selected from pulldown list box 314, as shown in FIG. 4, the predicted purchase date is selected from pulldown list box 314 and as shown in FIG. 5, the predicted purchase brand is selected.

At operation 1306, the correlation software module 220 calculates an accuracy of the prediction. The correlation software module 220 calculates the accuracy of the prediction based on the brand matches, context matches and keyword matches for the category. The correlation software module 220 uses a regression equation similar to equation (1). The correlation software module 220 uses the coefficient of determination R² to calculate the accuracy of the prediction.

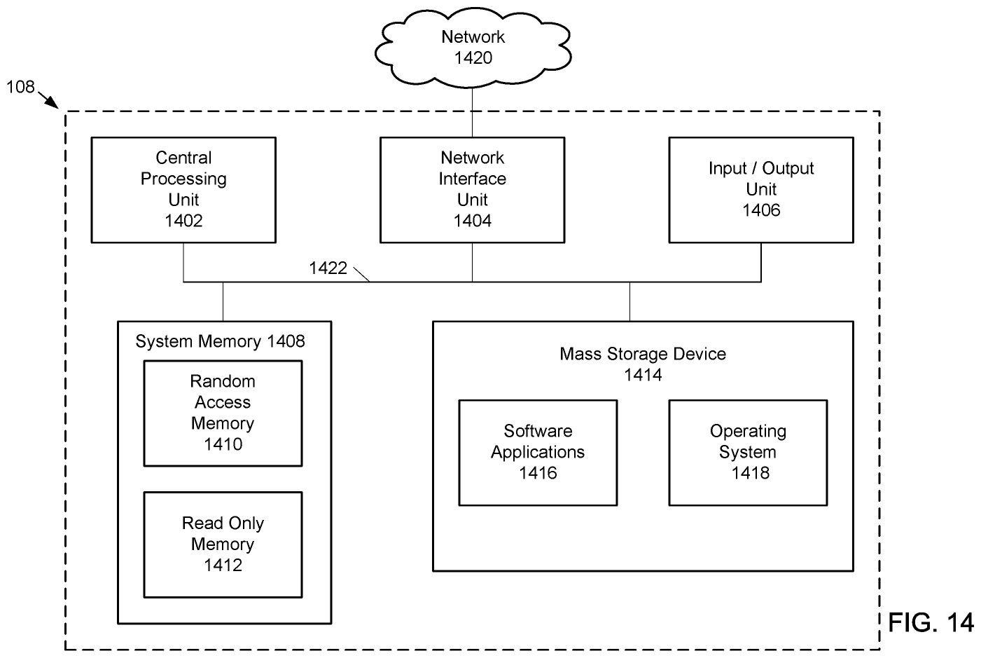

As illustrated in the example of FIG. 14, server computer 108 includes at least one central processing unit (“CPU”) 1402, a system memory 1408, and a system bus 1422 that couples the system memory 1408 to the CPU 1402. The system memory 1408 includes a random access memory (“RAM”) 1410 and a read-only memory (“ROM”) 1412. A basic input/output system that contains the basic routines that help to transfer information between elements within the server computer 108, such as during startup, is stored in the ROM 1412. The server computer 108 further includes a mass storage device 1414. The mass storage device 1414 is able to store software instructions and data.

The mass storage device 1414 is connected to the CPU 1402 through a mass storage controller (not shown) connected to the system bus 1422. The mass storage device 1414 and its associated computer-readable data storage media provide non-volatile, non-transitory storage for the server computer 108. Although the description of computer-readable data storage media contained herein refers to a mass storage device, such as a hard disk or solid state disk, it should be appreciated by those skilled in the art that computer-readable data storage media can be any available non-transitory, physical device or article of manufacture from which the central display station can read data and/or instructions.

Computer-readable data storage media include volatile and non-volatile, removable and non-removable media implemented in any method or technology for storage of information such as computer-readable software instructions, data structures, program modules or other data. Example types of computer-readable data storage media include, but are not limited to, RAM, ROM, EPROM, EEPROM, flash memory or other solid state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the server computer 108.

According to various embodiments of the invention, the server computer 108 may operate in a networked environment using logical connections to remote network devices through the network 1420, such as a wireless network, the Internet, or another type of network. The server computer 108 may connect to the network 1420 through a network interface unit 1404 connected to the system bus 1422. It should be appreciated that the network interface unit 1404 may also be utilized to connect to other types of networks and remote computing systems. The server computer 108 also includes an input/output controller 1406 for receiving and processing input from a number of other devices, including a touch user interface display screen, or another type of input device. Similarly, the input/output controller 1406 may provide output to a touch user interface display screen or other type of output device.

As mentioned briefly above, the mass storage device 1414 and the RAM 1410 of the server computer 108 can store software instructions and data. The software instructions include an operating system 1418 suitable for controlling the operation of the server computer 108. The mass storage device 1414 and/or the RAM 1410 also store software instructions, that when executed by the CPU 1402, cause the server computer 108 to provide the functionality of the server computer 108 discussed in this document. For example, the mass storage device 1414 and/or the RAM 1410 can store software instructions that, when executed by the CPU 1402, cause the server computer 108 to display received data on the display screen of the server computer 108.

Although various embodiments are described herein, those of ordinary skill in the art will understand that many modifications may be made thereto within the scope of the present disclosure. Accordingly, it is not intended that the scope of the disclosure in any way be limited by the examples provided.

1. A method implemented on an electronic computing device for predicting customer purchases, the method comprising:
on the electronic computing device, receiving from one or more retailers, via a retail ordering system application programming interface (API), ordering data regarding purchases made by a customer at the one or more retailers;
receiving from one or more social media sites, via a social media source application programming interface (API), social media posts made by the customer;
identifying, using a natural language processor, one or more first textual elements, one or more second textual elements and one more third textual elements by parsing and extracting elements from the social media posts, with the natural language processor defining:
a natural language processor data structure that organizes purchase information associated with the customer so that the purchase information can be stored, accessed and processed, including at least a product name; a context, a keyword, and a category associated with the purchase information; and
a historical data structure that organizes historical information associated with the purchase information, including at least the product name, a relevant date, and the category associated with the purchase information;
sorting each of the first textual elements and the second textual elements into one or more categories;
identifying one or more fourth textual elements from the ordering data;
sorting the one or more of fourth textual elements from the ordering data into the one or more categories;
for each of the one or more categories, calculating a sum of the first textual elements and the second textual elements from the social media posts; and
when the sum for the category is greater than a predetermined threshold:
generating a template from a plurality of templates associated with different categories, the template corresponding to the category, the template including a source, the context, and the keyword, and the template permitting a selection of one of a plurality of predictions related to the category;
receiving a selection from the template for a prediction of a purchase of a product or a service;
determining whether one of the first textual elements from the social media posts for the category matches one of the fourth textual elements from the ordering data for the category; and
when the one of the first textual elements from the social media posts for the category matches the one of the fourth textual elements from the ordering data for the category or when at least one of the second textual elements and one of the third textual elements from the social media posts are sorted into a same category and the category matches a category for at least one of the first textual elements from the social media posts:
making the prediction that the customer will purchase a product or a service corresponding to the category, including predicting a name of a brand for the product or the service to be purchased, with the brand identifying a brand name for the product or the service; and
displaying a correlation value indicating a degree of accuracy associated with the prediction on the template by comparing the brand name to brands in the ordering data, with the correlation value being calculated by fitting the ordering data to a regression line representing the prediction.

2. (canceled)

3. The method of claim 1, wherein when the one of the first textual elements from the social media posts for the category matches the one of the fourth textual elements from the ordering data for the category, filling in fields in the template with names of the one or more first textual elements, the one or more second textual elements and the one or more third textual elements for the category from the social media posts.

4. The method of claim 3, further comprising filling in a first field of the template with a predicted purchase price of the product or service corresponding to the category.

5. (canceled)

6. The method of claim 1, wherein the first textual elements from the social medial posts correspond to one or more products, brands, trade names or services mentioned in the social media posts.

7. The method of claim 1, wherein the second textual elements from the social media posts correspond to one or more keywords in the social media posts, the one or more keywords corresponding to generic words that can be sorted into categories.

8. The method of claim 1, wherein the third textual elements from the social media posts correspond to one or more context indicators in the social media posts, the one or more context indicators corresponding to words or phrases that can correspond to an action to be taken with respect to the first textual elements and/or the second textual elements.

9. The method of claim 1, wherein the fourth textual elements from the ordering data correspond to one or more products, brands, trade names or services that the customer has already purchased.

10-19. (canceled)

20. An electronic computing device comprising:
a processing unit; and
system memory, the system memory including instructions which, when executed by the processing unit, cause the electronic computing device to:
receive from one or more retailers, via a retail ordering system application programming interface (API), ordering data regarding purchases made by a customer at the one or more retailers;
receive from one or more social media sites, via a social media source application programming interface (API), social media posts made by the customer;
identify, using a natural language processor, one or more first textual elements by parsing and extracting elements from the social media posts, the one or more first textual elements from the social media posts corresponding to names of one or more products, brands, trade names or services mentioned in the social media posts;
identify one or more second textual elements from the social media posts, the one or more second textual elements in the social media posts corresponding to one or more keywords in the social media posts, the one or more keywords corresponding to generic words that can be sorted into categories;
identify one or more third textual elements from the social media posts, the one or more third textual elements in the social media posts corresponding to words or phrases that can correspond to an action to be taken with respect to the first textual elements and/or the second textual elements;
wherein the natural language processor defining:
a natural language processor data structure that organizes purchase information associated with the customer so that the purchase information can be stored, accessed and processed, including at least a product name; a context, a keyword, and a category associated with the purchase information; and
a historical data structure that organizes historical information associated with the purchase information, including at least the product name, a relevant date, and the category associated with the purchase information;
sort each of the first textual elements and the second textual elements into one or more categories;
identify one or more of fourth textual elements from the ordering data, the one or more fourth textual elements from the ordering data corresponding to one or more products, brands, trade names or services that the customer has already purchased;
sort the one or more of the fourth textual elements from the ordering data into the one or more categories;
for each of the one or more categories, calculate a sum of the first textual elements and the second textual elements from the social media posts;
when the sum for the category is greater than a predetermined threshold:
generate a template from the plurality of templates associated with different categories, the template corresponding to the category, the template including a source, the context and the keyword, and the template permitting a selection of one of a plurality of predictions related to the category; and
determine whether one of the first textual elements from the social media posts for the category matches one of the fourth textual elements from the ordering data for the category; and
when the one of the first textual elements from the social media posts for the category matches the one of the fourth textual elements from the ordering data for the category or when at least one of the second textual elements and one of the third textual elements from the social media posts are sorted into a same category and the category matches a category for at least one of the first textual elements from the social media posts:
fill in fields in the template with names of the one or more first textual elements, the one or more second textual elements and the one or more third textual elements for the category from the social media posts;
receive a selection for a predicted purchase price, a predicted purchase date or a predicted purchase brand;
based on the selection, fill in fields in the template with the predicted purchase price, the predicted purchase date or the predicted purchase brand for a product, with the purchase brand identifying a brand name or trade name for the product or service to be purchased; and
fill in a field in the template with a correlation value indicating a degree of accuracy of the predicted purchase price, the predicted purchase date or the predicted purchase brand by comparing the brand name to brands in the ordering data, with the correlation value being calculated by fitting the ordering data to a regression line representing the prediction.
